(19) United States
(12) Patent Application Publication
(10) Pub. No.: US 2015/0246300 A1
(43) Pub. Date: Sep. 3, 2015

(54) FILTRATION SYSTEMS HAVING FRONT FLUSH SUBSYSTEMS

(71) Applicant: CARDEN Water Systems, LLC, Phoenix, AZ (US)

(72) Inventor: Dennis Chancellor, Gilbert, AZ (US)

(73) Assignee: CARDEN WATER SYSTEMS, LLC, Phoenix, AZ (US)

(21) Appl. No.: 14/194,403

(22) Filed: Feb. 28, 2014

(51) Int. Cl. B01D 29/66

(52) U.S. Cl. CPC B01D 29/665

(57) ABSTRACT

Front flush subsystems and filtration systems including front flush subsystems are provided. In one embodiment, the filtration system includes a front flush subsystem and a filter unit, which separates a pressurized feed stream into a reject stream and a permeate stream. The front flush subsystem includes, in turn, a pressure vessel having a permeate inlet fluidly coupled to the filter unit and configured to receive the permeate stream therefrom, a permeate storage chamber fluidly coupled to the permeate inlet and configured to store permeate therein, and a permeate outlet fluidly coupled to the permeate storage chamber. A discharge mechanism is coupled to the pressure vessel. When actuated, the discharge mechanism blocks or otherwise interrupts permeate flow through the permeate outlet, while expelling the permeate stored in the permeate storage chamber through the permeate inlet such that permeate is temporarily flushed through the filter unit in a reverse direction.

### TECHNICAL FIELD

Embodiments of the present invention relate generally to filtration systems and, more particularly, to fluid filtration systems having front flush subsystems for flushing collected permeate through one or more filter units to reduce the accumulation of contaminants therein.

### BACKGROUND

Reverse osmosis water filtration systems and other fluid filtration systems use porous filter elements to separate a feed stream into a reject stream and a purified permeate stream. Over time, the filter elements become saturated with solid contaminants removed from the feed stream, which lodge within the filter element pores. Saturation of filter elements reduces filter performance, increases required pressure differentials, and may eventually necessitate replacement of the filter elements. Front flushing can be performed periodically to dislodge the solid matter from filter element pores and deter filter element saturation. Front flushing is ideally performed in-situ to avoid shutdown of the filtration system. Examples of subsystems capable of performing in-situ front flushing are described in co-pending U.S. application Ser. No. 13/804,134, entitled “FRONT FLUSH SYSTEMS AND METHODS,” filed Jul. 18, 2013, and assigned to the assignee of the present application, the contents of which are hereby incorporated by reference. While providing the above-noted benefits, conventional front flush subsystems remain limited in certain respects. For example, front flush subsystems often rely upon multiple valves and relatively complex plumbing networks to generate the stream or pulse of pressurized fluid applied to the filter units during front flushing. As a result, conventional front flush subsystems are often undesirably complex, bulky, energy inefficient, and costly to produce and operate. In many cases, conventional front flush subsystems are also equipped with various pressure limiting components to avoid damaging the filter elements, which may be relatively delicate and unable to tolerate exposure to high pressures without damage.

It is thus desirable to provide embodiments of filtration system including a front flush subsystem, which has a reduced complexity, part count, and cost as compared to conventional front flush subsystem. Ideally, such a front flush subsystem would provide in-situ front flushing of filtration system's filter elements without requiring system shutdown or a decrease in the normal operational pressure of the filtration system. It would also be desired if, at least in some embodiments, the front flush subsystem enabled flushing to be performed at high pressures and in a relatively brief time period without risk of damage to the filter elements. Other desirable features and characteristics of the present invention will become apparent from the subsequent Detailed Description and the appended Claims, taken in conjunction with the accompanying Drawings and the foregoing Background.

### BRIEF SUMMARY

Filtration systems including front flush subsystems are provided. In one embodiment, the filtration system includes a front flush subsystem and a filter unit, which is configured to separate a pressurized feed stream into a reject stream and a permeate stream. The front flush subsystem includes, in turn, a pressure vessel having a permeate inlet fluidly coupled to the filter unit and configured to receive the permeate stream therefrom, a permeate storage chamber fluidly coupled to the permeate inlet and configured to store a predetermined volume of permeate therein, and a permeate outlet fluidly coupled to the permeate storage chamber. A discharge mechanism is coupled to the pressure vessel. When actuated, the discharge mechanism blocks or otherwise interrupts permeate flow through the permeate outlet, while expelling at least a portion of the permeate stored in the permeate storage chamber through the permeate inlet such that permeate is temporarily flushed through the filter unit in a reverse direction.

Front flush subsystems are further provided. The front flush subsystems are utilized in conjunction with at least one filter unit configured to separate a pressurized feed stream into a reject stream and a permeate stream. In one embodiment, the front flush subsystem includes a pressure vessel having a permeate inlet configured to receive the permeate stream from the at least one filter unit, a permeate storage chamber fluidly coupled to the permeate inlet and configured to store a predetermined volume of permeate therein, and a permeate outlet fluidly coupled to the permeate storage chamber. A discharge mechanism coupled to the pressure vessel. When actuated, the discharge mechanism interrupts permeate flow through the permeate outlet, while expelling at least a portion of the permeate stored in the permeate storage chamber through the permeate inlet such that permeate is temporarily flushed through the filter unit in a reverse direction.

### BRIEF DESCRIPTION OF THE DRAWINGS

At least one example of the present invention will hereinafter be described in conjunction with the following figures, wherein like numerals denote like elements, and:

FIGS. 1 and 2 are schematics of a filtration system including a front flush subsystem shown during normal operation (FIG. 1) and during front flushing (FIG. 2), as illustrated in accordance with an exemplary embodiment of the present invention;

FIGS. 3 and 4 are cross-sectional views of the pressure vessel included within the front flush subsystem shown in FIGS. 1 and 2 and illustrating a fluid-driven piston in standby and flush positions, respectively;

FIGS. 5 and 6 are schematics of a front flush subsystem including a solenoid-actuated piston in standby and flush positions, respectively, as illustrated in accordance with a further exemplary embodiment of the present invention; and

FIGS. 7 and 8 are schematics of a piston-less front flush subsystem shown prior to and during front flushing, respectively, as illustrated in accordance with a still further exemplary embodiment of the present invention.

For simplicity and clarity of illustration, the drawing figures illustrate the general manner of construction, and descriptions and details of well-known features and techniques may be omitted to avoid unnecessarily obscuring the exemplary and non-limiting embodiments of the invention described in the subsequent Detailed Description. It should further be understood that features or elements appearing in the accompanying figures are not necessarily drawn to scale unless otherwise stated. For example, the dimensions of certain elements or regions in the figures may be exaggerated relative to other elements or regions to improve understanding of embodiments of the invention.

### DETAILED DESCRIPTION

The following Detailed Description is merely exemplary in nature and is not intended to limit the invention or the application and uses of the invention. Furthermore, there is no intention to be bound by any theory presented in the preceding Background or the following detailed description.

The following describes embodiments of filtration systems including front flush subsystems useful in flushing one or more filter units with collected permeate to reduce the accumulation of contaminants therein. As compared to other known front flush systems, the front flush subsystems described herein have a reduced complexity, part count, and cost. Embodiments of the front flush subsystems require relatively few, if any, valves in performing the front flush operation to improve overall system efficiency and minimize energy requirements. In certain embodiments, the front flush subsystems generate relatively rapid, high pressure flush streams or pulses during front flushing. In such embodiments, the front flush subsystems are especially well-suited for usage in conjunction with rigid porous tubular filter elements, such as those commonly employed in Total Suspended Solids (TSS) filtration systems, which can withstand relatively large pressures differentials without damage. Such high pressure front flushing may enhance filter element cleaning, while easing control constraints that may otherwise be placed on the front flush subsystems when utilized with less robust filter elements, such as spiral wound filter elements.

In preferred embodiments, the filtration system may be implemented as a water filtration system and, specifically, a Reverse Osmosis (RO) filtration system. In such embodiments, the feed stream may be a liquid feed water stream; and the filter units may be cross-flow RO filter units. This notwithstanding, it is emphasized that the filtration system can be utilized to filter and thereby purify various different types of liquids. For example, the filtration system may be utilized to purify chemical and hydrocarbon streams in at least some implementations. Additionally, the filtration system described herein can employ various different types of filter units, as selected based upon the type of feed stream to be purified, the minimum permissible contaminant size, and other such parameters. Thus, as appearing herein, the term “filter element” is defined to include all commercially suitable filters including, for example, sand, charcoal, paper, and other media, and any membrane capable of filtering a fluid. The filter element can be of any type, size, and configuration.

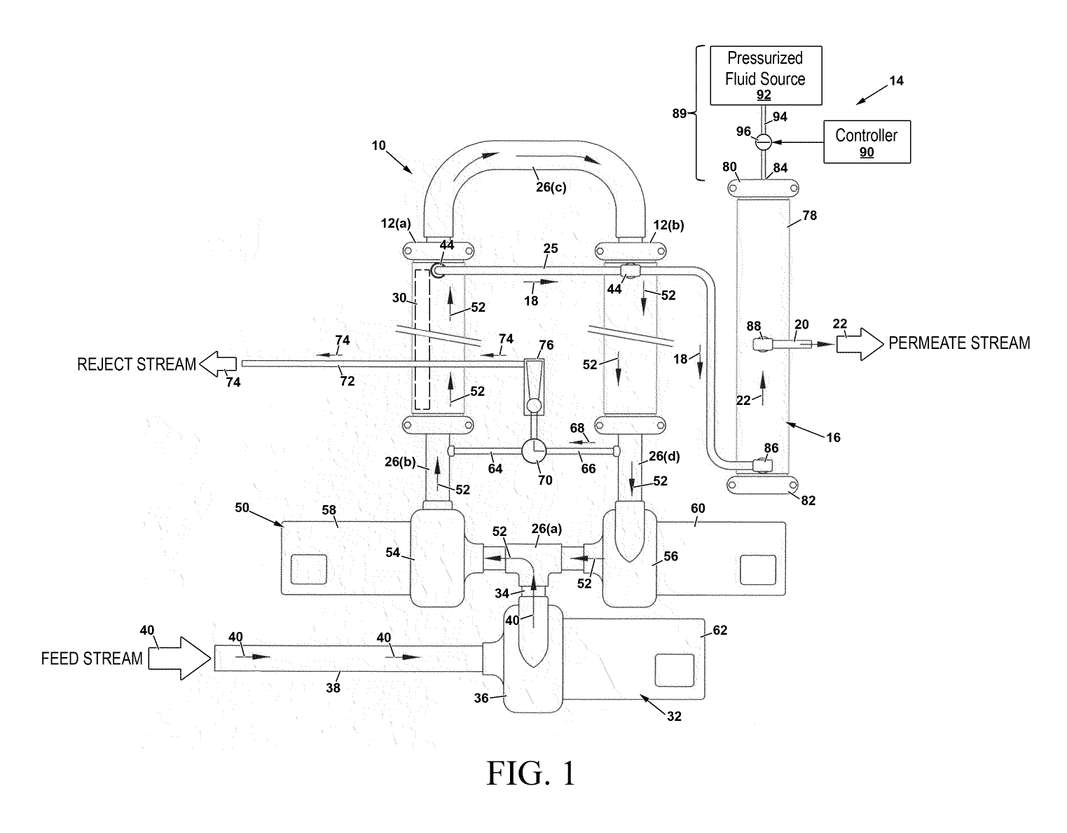

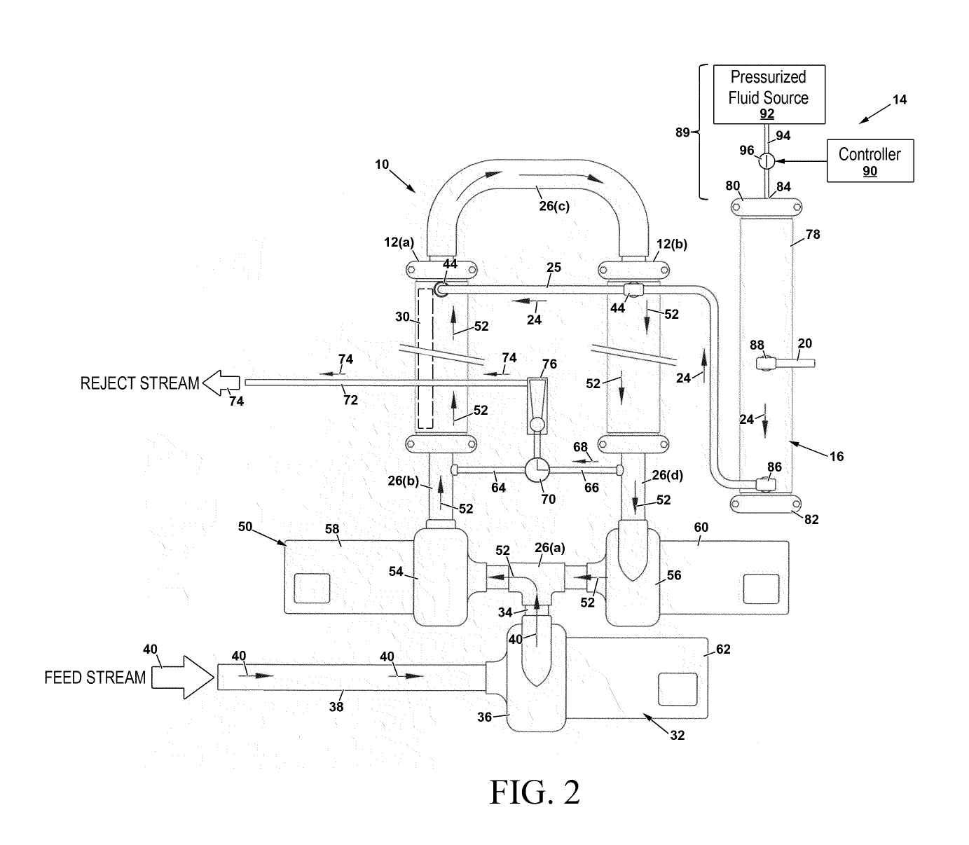

FIGS. 1 and 2 are schematics of a liquid filtration system 10 including one or more filter units 12 and a front flush subsystem 14, as illustrated in accordance with an exemplary embodiment of the present invention. As will be described more fully below, front flush subsystem 14 is operable in a standby mode (shown in FIG. 1) and a front flush mode (shown in FIG. 2) during which subsystem 14 generates a pressurized pulse or stream of permeate to flush filter units 12 and thereby clean the filter elements contained therein. First, however, a general description of liquid filtration system 10 is provided to establish an exemplary context in which the operation of front flush subsystem 14 can be better understood. While described below in conjunction with a particular type of filtration system, it is emphasized that front flush system 14 can be utilized in conjunction with or integrated into any filtration system containing one or more porous filter elements, which are used to remove solid contaminants from a feed stream to produce a purified permeate stream and which are amenable to cleaning by front flushing. Furthermore, in certain cases, front flush subsystem 14 may be retrofitted onto an existing liquid filtration system by, for example, installing subsystem 14 at any location downstream of the filter unit or units included within the filtration system.

In the illustrated exemplary embodiment, filtration system 10 includes a number of conduits 26(a)-26(d), which are fluidly coupled together to form reversible flow loop 26. Conduits 26(a)-26(d) can be pipes, hoses, or any other component or structure having flow passages therethrough suitable for conducting a fluid under pressure, such as the below-described pressurized feed stream. As noted above, one or more filter units 12 are positioned in reversible flow loop 26. For example, as shown in FIGS. 1 and 2, filtration system 10 may include two such filters units 12(a) and (b), which are fluidly coupled in series by conduit 26(c). In other embodiments, filtration system 10 may include a greater or lesser number of filter units, which may be fluidly coupled in parallel, in series, or a series-parallel combination. As a more specific example, filtration system 10 may include multiple banks of filter units, which are fluidly coupled in parallel and which contain two or more filter units fluidly coupled in series in further implementations.

Filter units 12 are preferably cross-flow RO filter units, which each include vertically-oriented pressure vessel containing one or more vertically-oriented RO filter elements. The vertically-oriented RO filter elements can be, for example, a number of rigid tubular filters (one of which is illustrated in phantom in FIGS. 1 and 2 and identified by reference numeral “30”). In this case, filter elements 30 may assume the form of rigid, elongated tubes having a controlled porosity and able to withstanding significant external pressures (e.g., pressures approaching or exceeding 200 pounds-per-square inch or “psi”) without damage or structural degradation. Such rigid tubular filter elements are often produced from rigid polymers, ceramics, or similar materials and should be contrasted with spiral-wound filter elements and other soft membranes, which are considerably more delicate and may tolerate much lower pressure levels (e.g., maximum pressures less than 10 psi) without risk of tearing or otherwise sustaining damage. As can filter units 12 generally, filter elements 30 can be produced to virtually any desired dimensions and are commonly produced to range from about two to about six meters in length. This notwithstanding, it will be appreciated that various other types of filter elements can be utilized within filter units 12 suitable for removing particulate matter, molecular matter, and other contaminants from a feed stream to produce a purified permeate stream, such as a purified water stream.

A pressurized feed stream source 32 is fluidly coupled to an inlet 34 of flow loop 26 and supplies a pressurized feed stream thereto. In the exemplary embodiment shown in FIGS. 1 and 2, inlet 34 is defined by a three-way conduit 26(a) included within flow loop 26. Conduit 26(a) may also be referred to as a “blending tee” herein as fresh feed supplied by feed stream source 32 continually mixes with a recycled portion of the reject stream within conduit 26(a) during operation of system 10. Pressurized feed stream source 32 can assume any form suitable for providing a feed stream to flow loop inlet 34 at a particular pressure or range of pressures. For example, pressurized feed stream source 32 can assume the form of a liquid column providing a static pressure head and held by a standpipe, a storage tank, or other vessel. Alternatively, as generally illustrated in FIGS. 1 and 2, pressurized feed stream source 32 may include a main pump 56, which draws feed from a supply conduit 25 and then injects the feed stream into inlet 34 of flow loop 26 at a controlled pressure (as indicated by arrows 40). Reversible low loop 26 then directs the pressurized feed stream through filter units 12, which separates the feed stream into reject and permeate streams. The respective permeate outlets of filter units 12 are fluidly connected by couplings 44 to permeate conduit 45, which (during normal operation) directs the consolidated permeate stream into a pressure vessel 16 included within front flush subsystem 14, as described more fully below.

A pump-driven, flow-reversing subsystem 50 is further positioned in reversible flow loop 26. Flow-reversing subsystem 50 is operable in at least two modes: a forward flow mode (shown in FIGS. 1 and 2) and a reverse flow mode (not shown). In the forward flow mode, flow-reversing subsystem 50 pressurizes the fluid within reversible flow loop 26 to flow through loop 26 and filter units 12 in a forward flow direction, as indicated in FIGS. 1 and 2 by arrows 52. Conversely, in the reverse flow mode, flow-reversing subsystem 50 pressurizes the fluid within reversible flow loop 26 to flow through loop 26 and filter units 12 in a reverse flow direction. In the illustrated embodiment, flow-reversing subsystem 50 includes a forward flow pump 54 and a reverse flow pump 56, which are positioned in reversible flow loop 26 such that blending tee 26(a) is fluidly coupled between pumps 54 and 56. When energized or otherwise driven, forward flow pump 54 urges fluid flow in the forward flow direction (FIG. 1), while reverse flow pump 56 remains quiescent (whether inactivated or in a low-power state) and allows fluid backflow therethrough. Conversely, reverse flow pump 56 (when energized) urges fluid flow in the reverse flow direction, while forward flow pump 54 remains quiescent and allows fluid backflow therethrough. A controller (not shown) may thus selectively energize pumps 54 and 56 to achieve the desired flow direction as determined by the particular operational mode of flow-reversing subsystem 50.

Pumps 54 and 56 are preferably controlled to provide a gradual transition between the forward flow and reverse flow modes. Thus, when transitioning from the forward flow mode to the reverse flow mode, forward flow pump 54 may be controlled to gradually decrease its output, while reverse flow pump 56 is simultaneously controlled to gradually increase its output. Similarly, when returning to the forward flow mode from the reverse flow mode, reverse flow pump 56 may be controlled to gradually decrease its output, while forward flow pump 54 is simultaneously controlled to gradually increase its output. In one embodiment, flow pumps 54 and 56 are driven by Variable Frequency Drives (VFDs) 58 and 60, respectively, which are operably coupled to the non-illustrated controller. Main pump 36 may likewise be controlled through an additional VFD 62. Further description of filtration systems including flow-reversing subsystems of this type can be found in co-pending U.S. application Ser. No. ______, entitled “FILTRATION SYSTEMS HAVING FLOW-REVERSING SUBSYSTEMS AND ASSOCIATED METHODS,” filed Feb. 28, 2014, and assigned to the assignee of the present application, the contents of which are hereby incorporated by reference. By pairing front flush subsystem 14 with flow-reversing subsystem 50, which may periodically cycle between the forward flow and reverse flow modes, the filter elements contained within filter units 12 can be maintained in a highly clean state to optimize the efficiency of filtration system 10 and maximize filter element life. These advantages notwithstanding, filtration system 10 is by no means required to include a flow-reversing subsystem in all embodiments.

As filter units 12 are coupled in flow series, the reject stream discharged by the upstream filter unit 12 is supplied to the downstream filter unit 12, which may be either filter unit 12(a) or filter unit 12(b) depending upon the operational mode of flow-reversing subsystem 50. The impurity concentration of the reject stream increases at each stage of filtration. The last filter unit 12 in the series then discharges the highly concentrated reject stream into reversible flow loop 26. First and second permeate drain lines 64 and 66 are fluidly coupled to reversible flow loop 26 to remove a portion of the highly concentrated reject stream discharged into loop 26 from the final filter unit 12 in the flow series. More specifically, permeate drain line 66 (referred to herein as the “forward drain line”) is utilized to remove a portion of the reject stream discharged by final filter unit 12(b) in flow series when flow-reversing subsystem 50 operates in the forward flow mode, as indicated in FIGS. 1 and 2 by arrows 68. Similarly, permeate drain line 64 (referred to herein as the “reverse drain line”) removes a portion of the reject stream discharged by final filter unit 12(a) when flow-reversing subsystem 50 operates in the reverse flow mode (not shown).

To prevent undesired siphoning of the feed stream upstream of filter units 12, fluid flow through drain lines 64 and 66 is selectively blocked or impeded depending upon the operational mode of flow-reversing subsystem 50. In this regard, a flow control valve 70 may be fluidly coupled between drain line 64 and drain line 66. Flow control valve 70 is further fluidly coupled to a consolidated drain line 72 through which the concentrated reject stream may be removed from system 10 (indicated in FIGS. 1 and 2 by arrows 74). Flow control valve 70 is a three-way valve movable between: (i) a first position (shown in FIGS. 1 and 2) in which valve 70 fluidly couples forward drain line 66 and consolidated drain line 72, while blocking flow through reverse drain line 64, and (ii) a second position (not shown) in which valve 70 fluidly couples reverse drain line 64 and consolidated drain line 72, while blocking flow through forward drain line 66. Thus, by commanding flow control valve 70 to move between the first and second positions, a portion of the reject stream discharged by the final filter unit 12 in flow series can be withdrawn from system 10 immediately downstream of filter units 12, regardless of the particular mode in which flow-reversing subsystem 50 is operating. The appropriate commands can be issued by a non-illustrated controller operably coupled to the actuator of valve 70. Any three-way valve suitable for selectively coupling drain lines 64, 66, and 58 may be utilized for this purpose including, but not limited to, L-valves and ball valves. In further embodiments, flow control valve 70 may be replaced by two or more two-way valves, which are controlled to selectively allow fluid flow through drain lines 64 and 66 in the above-described manner. If desired, a rotameter 76 may be positioned in consolidated drain line 72 to provide a flow rate readout for the concentrated reject stream withdrawn from system 10.

Front flush subsystem 14 normally operates in the standby mode (FIG. 1) during which pressure vessel 16 receives the consolidated permeate stream (indicated in FIG. 1 by arrows 18) and then discharges the permeate stream into a downstream permeate conduit 20. The permeate stream may thus be withdrawn from filtration system 10 through pressure vessel 16 (indicated in FIG. 1 by arrows 22) such that front flush subsystem 14 is effectively transparent to system 10 during normal operation. As appearing herein, the term “pressure vessel” is defined to encompass any structure, assembly, or housing, regardless of shape, construction, or orientation, suitable for storing and expelling permeate in the below described manner. In the exemplary embodiment shown in FIGS. 1 and 2, pressure vessel 16 includes a vertically-oriented cylinder 78, an upper end cap 80 sealingly joined to the upper end of cylinder 78, and a lower end cap 82 sealingly joined to the lower end of cylinder 78. A control fluid inlet 84 is provided through upper end cap 80, and a permeate inlet 86 is provided through lower end cap 82. A permeate outlet 88 is further provided through the sidewall of cylinder 78 at a location between control fluid inlet 84 and permeate inlet 86; e.g., permeate outlet 88 may be located in a middle portion of pressure vessel 16, while permeate inlet 86 is located in a lower portion of vessel 16 beneath outlet 88.

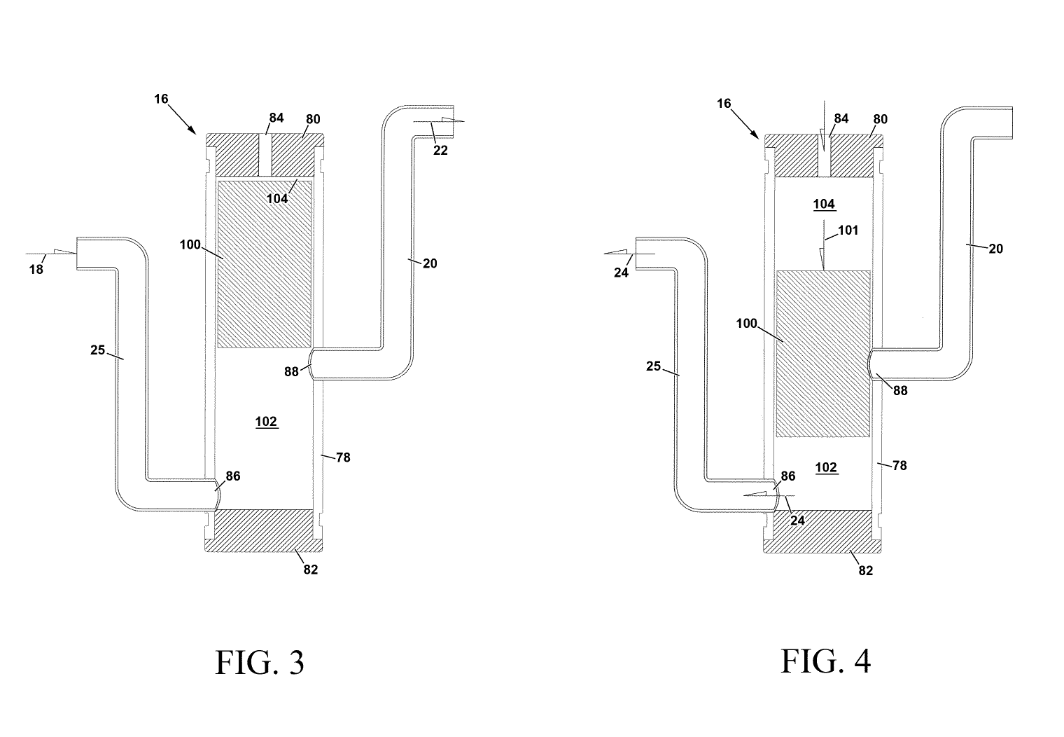

Front flush subsystem 14 further includes a discharge mechanism 89 and a controller 90. Discharge mechanism 89 is coupled to pressure vessel 16 and, in certain embodiments, may be housed partially or wholly therein. Discharge mechanism 89 can include any number of devices or components, which can be utilized to expel the permeate stored in pressure vessel 16 through permeate inlet 86 in the below-described manner. In the embodiment shown in FIGS. 1 and 2, discharge mechanism 89 includes a pressurized fluid source 92, which is fluidly coupled to control fluid inlet 84 by a flow line 94. A flow control valve 96 is positioned in flow line 94 and operably coupled to controller 90. In response to command signals generated by controller 90, flow control valve 96 moves between a closed position (FIG. 1) and an open position (FIG. 2). During normal operation of filtration system 10 (FIG. 1), flow control valve 96 remains in the closed position wherein valve 96 prevents pressurized fluid flow from pressure source 92 into control fluid inlet 84. When it is desired to front flush filter units 12, controller 90 commands flow control valve 96 to move into an open position (FIG. 2) allowing pressurized fluid to from pressurized fluid source 92 into inlet 84 of pressure vessel 16. A stored volume of permeate is consequently expelled from front flush subsystem 14 under pressure and flows through filter units 12 in a reverse direction (indicated in FIG. 2 by arrows 24). At the same time, front flush subsystem 14 blocks permeate outlet 88 to interrupt the flow of permeate therethrough. Notably, front flush subsystem 14 performs both of these functions utilizing a relatively simple, valveless piston-based design, as described more fully below in conjunction with FIGS. 3 and 4.

FIGS. 3 and 4 are cross-sectional views of pressure vessel 16 as illustrated prior to and during actuation of front flush subsystem 14, respectively. It can be seen in FIGS. 3 and 4 that front flush subsystem 14 further includes a piston 100, which is slidably disposed within pressure vessel 16 for movement between a standby position (FIG. 3) and a flush position (FIG. 4). Piston 100 cooperates with pressure vessel 16 to define a permeate storage chamber 102, which is located within a lower portion of vessel 16 and fluidly coupled between permeate inlet 86 and permeate outlet 88. Furthermore in the standby position (FIG. 3), a control chamber 104 is defined by piston 100 and pressure vessel 16 and fluidly coupled to control fluid inlet 84. When piston 100 resides in the standby position (FIG. 3), permeate storage chamber 102 stores a predetermined volume of permeate collected from the permeate stream supplied to pressure vessel 16 by permeate conduit 25. Additionally, piston 100 does not obstruct permeate outlet 88. Consequently, permeate may freely flow from permeate inlet 86, through chamber 102, and to permeate outlet 88 and ultimately be removed from front flush subsystem 14 through downstream permeate conduit 20

When determining that front flushing should be performed, controller 90 (FIGS. 1 and 2) opens flow control valve 96 and pressurized fluid flows from source 92, through control fluid inlet 84, and into control chamber 104 (indicated by arrow 101 in FIG. 4). The pressurized fluid acts on the effective surface area of piston 100 in opposition to the force exerted on piston 100 by the permeate within permeate storage chamber 102. The pressurized fluid exerts sufficient force on piston 100 to force piston to move from the standby position (FIG. 3) toward the flush position (FIG. 4). When moving toward the flush position (FIG. 4), piston 100 physically obstructs permeate outlet 88 to fluidly isolate outlet 88 from permeate storage chamber 102. In this manner, front flush subsystem 14 blocks fluid outflow through permeate outlet 88 during front flushing without the usage of a separate valve. At the same time, the downward movement of piston 100 forces permeate stored within permeate storage chamber 102 to be expelled through permeate inlet 86 such that permeate is temporarily flushed through filter units 12 in a reverse direction, as previously described. Various different types of pressurized fluid may be utilized to drive piston 100 into the flush position (FIG. 4) including liquids, such as a diverted portion of the feed stream, reject stream, or permeate stream. It is preferred, however, that pressurized air is utilized to move piston 100 into the flush position (FIG. 4), in which case pressurized fluid source 92 (FIGS. 1 and 2) may include an air compressor or a tank containing pressurized air.

After actuation of front flush subsystem 14, piston 100 returns to the standby position shown in FIG. 3 and a predetermined volume of permeate is again collected within permeate storage chamber 102. In preferred embodiments, pressure vessel 16 is vertically oriented, permeate store chamber 102 is formed in a lower portion of pressure vessel 16, and piston 100 is produced to have a positive buoyancy relative to the permeate stored in chamber 102. In this manner, piston 100 may effectively float in the permeate and need not have additional means for returning to the standby position. Furthermore, in such embodiments, piston 100 need not sealingly engage the inner circumference of pressure vessel 16. Instead, an annular clearance may be provided around piston 100 such that fluid communication is permitted between permeate storage chamber 102 and control chamber 104. The need for O-rings or other dynamic seals carried by piston 100 is thus eliminated to help simply the construction of front flush subsystem 14. In further embodiments, piston 100 may be biased toward the standby position utilizing, for example, a coil spring. Although not shown in FIGS. 3 and 4, a vent valve may further be fluidly coupled to control chamber 104 and selectively opened by controller 90 to allow venting of chamber 104 when piston 100 returns to the standby position (FIG. 3) after actuation of front flush subsystem 14. In further embodiments, controlled venting of chamber 104 may be accomplished utilized a three way flow control valve in place of valve 96. In still further embodiments, front flush subsystem 14 may be designed such that piston 100 strokes upward when moving from the standby position to the flush position. In such embodiments, piston 100 may be imparted with a negative buoyancy such that piston 100 sinks beneath the collected permeate to return to the standby position after actuation of subsystem 14.

Controller 90 may initiate the above-described front flushing process in response to a manual command. Alternatively, controller 90 may automatically determine when to perform front flushing based upon one or more predetermined criteria. For example, controller 90 may utilize one or more non-illustrated sensors to measure the pressure drop across filter units 12 indicative of filter saturation and initiate front flushing when the pressure drop surpasses a predetermined threshold. Front flushing is advantageously performed in-situ during operation of filtration system 10 without requiring a decrease in the normal operational pressure thereof. In embodiments wherein filter units 12 contain filter elements able to withstand high pressures without damage, such as rigid tubular filter elements of the type described above, front flush subsystem 14 is advantageously configured to generate a high pressure stream or pulse of permeate during front flushing. For example, if the standard operation pressure of filtration system 10 were about 200 psi, front flush subsystem 14 may generate a permeate pulse having a pressure that is about 10 to 20 psi greater than the normal system pressure to provide a cumulative front flush pressure of about 210 to 220 psi. The duration over which front flush subsystem 14 generates the front flush stream or pulse is also advantageously controlled to be relatively brief and, possibly, on the order of a second or less. In this manner, a rapid and aggressive front flush pulse can be generated to quickly, effectively, and safely clean the filter elements contained in filter units 12.

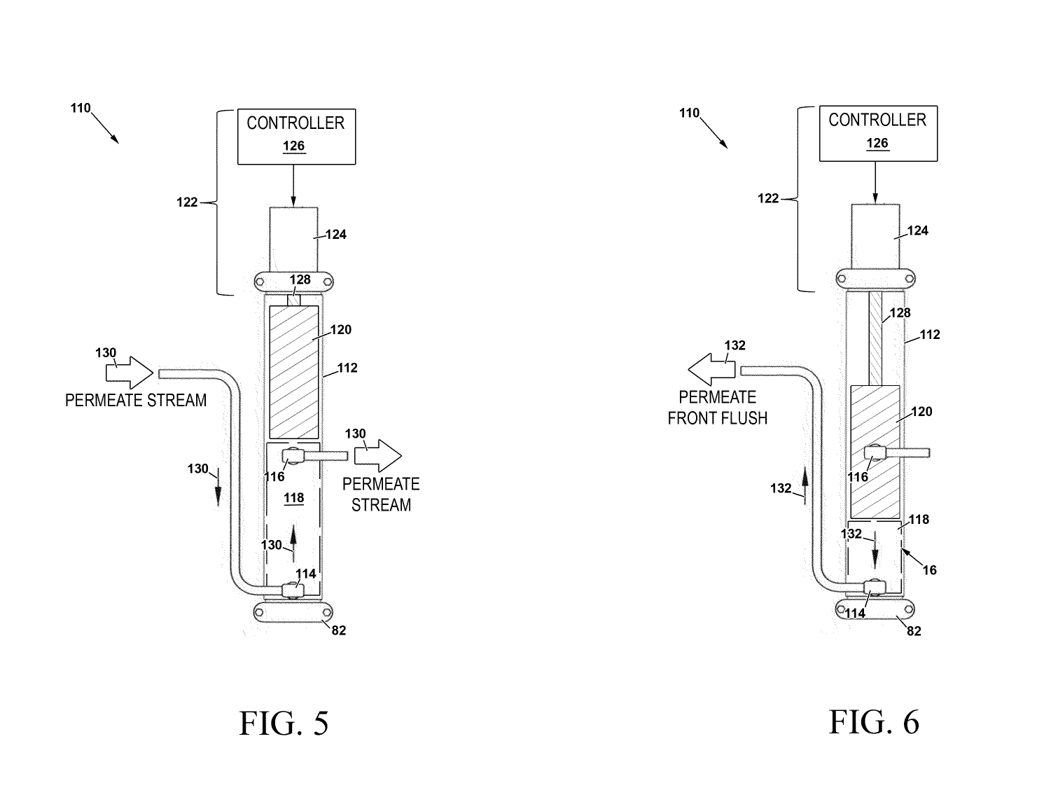

The foregoing has thus described an exemplary embodiment of a filtration system including a front flush subsystem, which allows in-situ front flushing of one or more filter units without the usage of a complex valved system. As a result, the above-described front flush subsystem has a reduced complexity, part count, and cost as compared to other known front flush subsystems. Additionally, in embodiments wherein the filter units contain porous rigid filter elements or other filter elements able to withstand relatively high pressure differentials, the front flush subsystem may generate high pressure pulses of permeate during front flushing to enhance cleaning of the filter elements. In the above-described exemplary embodiment, discharge mechanism 89 utilized a pressurized fluid source (i.e., pressurized fluid source 92 shown in FIGS. 1 and 2) to move piston 100 from the standby position (FIG. 3) to the flush position (FIG. 4) during front flushing. In further embodiments, discharge mechanism 89 may utilize a different actuator or driver to move piston 100 into the flush position upon actuation of the front flush subsystem. To further illustrate this point, a second exemplary embodiment of a front flush subsystem including a solenoid-driven piston will now be described below in conjunction with FIGS. 5 and 6.

FIGS. 5 and 6 schematically illustrate a second exemplary front flush subsystem 110 in standby and front flush modes, respectively. In many regards front flush subsystem 110 is similar to front flush system 14 described above in conjunction with FIGS. 1-4. For example, front flush subsystem 110 includes a pressure vessel 112 having a permeate inlet 114, a permeate outlet 116, and permeate storage chamber 118 (shown in phantom) fluidly coupled between inlet 114 and outlet 116. Permeate inlet 114 and permeate outlet 116 are formed in lower and mid portions of pressure vessel 112, respectively. As was previously the case, a piston 120 is mounted in vessel 112 for movement between a standby position (FIG. 5) and a flush position (FIG. 6). However, in contrast to front flush system 14 (FIGS. 1-4), piston 120 is moved into the flush position utilizing a solenoid-based discharge mechanism 122, which includes a solenoid 124 and a controller 126 operably coupled thereto. Solenoid 124 includes, in turn, a plunger 128 attached to piston 120 and biased toward a retracted position (FIG. 5). When piston 120 is in the retracted position (FIG. 5), permeate supplied to inlet 114 may flow through chamber 118 and vessel 112 through outlet 116 (indicated in FIG. 5 by arrows 130). When determining that front flushing should be performed, controller 126 energizes solenoid 124 to extend plunger 128 and drive piston 120 into the flush position (FIG. 6). Once again, this results in blockage of permeate outlet 116 and expulsion of the permeate stored in permeate storage chamber 118 through permeate inlet 114 (represented in FIG. 6 by arrows 132) thereby flushing permeate through any filter units fluidly coupled to inlet 114 of pressure vessel 112, such as filter units 12 shown in FIGS. 1 and 2.

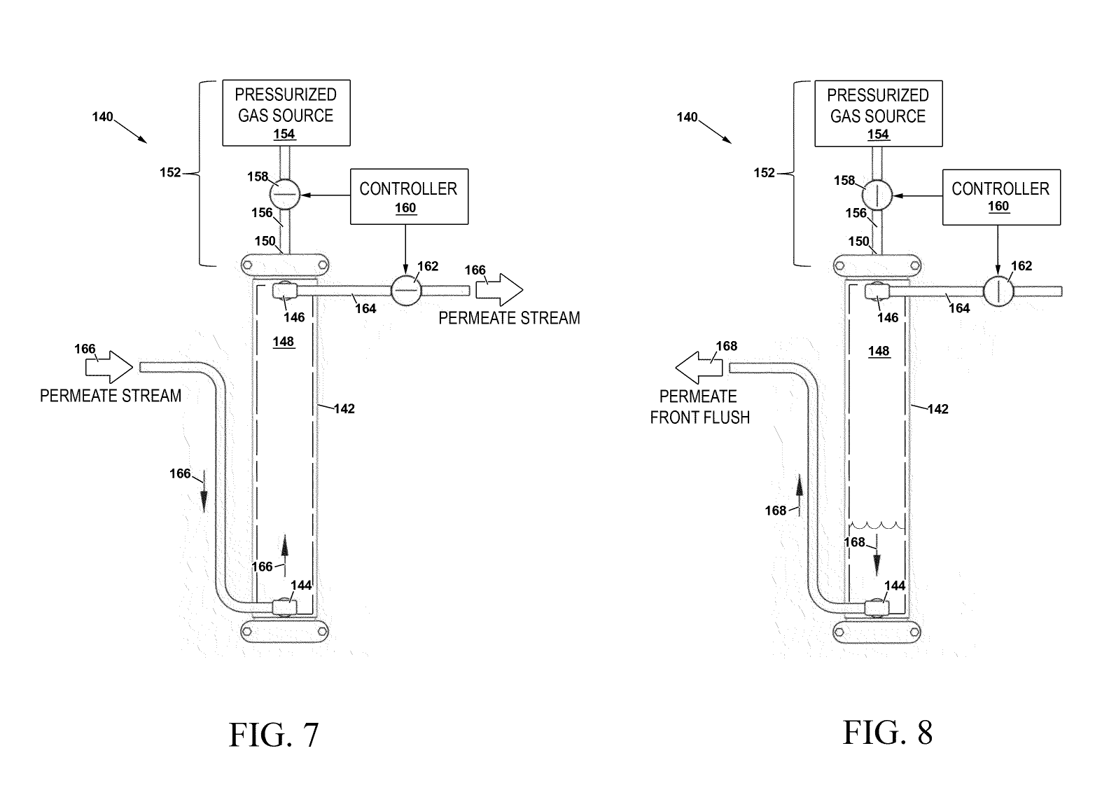

In the embodiments shown in FIGS. 1-6, the front flush subsystem utilized a piston to expel the collected permeate from the pressure vessel during the front flushing process. However, in further embodiments, the front flush subsystem may include a pistonless discharge mechanism. Consider, for example, FIGS. 7 and 8 schematically illustrating a front flush subsystem 140 in accordance with a further exemplary embodiment of the present invention. As does front flush subsystem 14 (FIGS. 1-4), front flush subsystem 140 includes a pressure vessel 142 having a permeate inlet 144, a permeate outlet 146, permeate storage chamber 148 (shown in phantom), and a control pressure inlet 150. A discharge mechanism 152 is operably coupled to pressure vessel 142 and includes a pressurized fluid source 154 (here, a pressurized gas source) fluidly coupled to control pressure inlet 150 via a flow line 156. A flow control valve 158 is positioned in flow line 156 and operably coupled to a controller 160. As commanded by controller 160, flow control valve 158 is movable between: (i) a closed position (FIG. 7) wherein valve 158 prevents pressurized gas flow from pressurized gas source 154 into permeate storage chamber 148, and (ii) an open position (FIG. 8) wherein valve permits pressurized gas flow from source 154 into chamber 148. A second flow control valve 162 may also be operably coupled to controller 160 and positioned in a downstream permeate conduit 164 fluidly coupled to permeate outlet 146.

When front flush subsystem 140 is in standby mode (FIG. 7), flow control valve 158 resides in a closed position and permeate fills permeate control chamber 148 and, more generally, pressure vessel 142. Permeate received at permeate inlet 144 thus flows through permeate storage chamber 148, is discharged from permeate outlet 146, and received by downstream permeate conduit 164 (as indicated in FIG. 7 by arrows 166). When it is desired to initiate front flushing, controller 160 commands valve 158 to move into an open position and pressurized gas is permitted to flow from source 154, through flow line 156, through inlet 150, and into permeate storage chamber 148. The pressurized gas is supplied at a sufficient pressure to force the column of permeate stored within chamber 148 to be expelled through inlet 144 thereby generating the desired front flush stream or pulse (indicated in FIG. 8 by arrows 168). Flow of the permeate through outlet 146 is interrupted or cutoff as the pressurized gas forces the column of permeate downward past the location of permeate outlet 146. When opening flow control valve 158, controller 160 may also close flow control valve 162 to prevent escape of the pressurized gas through permeate conduit 164. After front flushing has been completed, controller 160 may return valves 158 and 162 to closed and opened positions, respectively. After permeate storage chamber 148 fills with a stored volume of permeate, permeate may freely flow through pressure vessel 142 until front flush subsystem 140 is actuated once again.

There have thus been provided multiple exemplary embodiments of filtration system including a front flush subsystem, which has a reduced complexity, part count, and cost as compared to conventional front flush subsystem. In at least some of the above-described embodiments, the front flush subsystem would provide in-situ front flushing of filtration system's filter elements without require system shutdown or a decrease in the normal operational pressure of the filtration system. In embodiments wherein the front flush system is utilized in conjunction with structurally robust filter elements, such as rigid porous tubular filter elements of the type commonly utilized in TSS filtrations systems, the front flush subsystem can also be utilized to carry-out front flushing at high pressures and in a relatively brief time period without risk of damage to the filter elements. In this manner, the front flush subsystem can be utilized to quickly and effectively dislodge contaminants from the filter elements to prolong filter element life and improve the overall operational efficiencies of the filtration system. While described above in conjunction with a particular type of filtration system for the purposes of explanation, it is emphasized that embodiments of the front flush subsystem can be utilized in conjunction with other types of liquid filtration systems, which utilize porous filter elements to separate a feed stream into reject and permeate streams.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A filtration system, comprising:
a filter unit configured to separate a pressurized feed stream into a reject stream and a permeate stream; and
a front flush subsystem, comprising:
a pressure vessel having a permeate inlet fluidly coupled to the filter unit and configured to receive the permeate stream therefrom, a permeate storage chamber fluidly coupled to the permeate inlet and configured to store a predetermined volume of permeate therein, and a permeate outlet fluidly coupled to the permeate storage chamber; and
a discharge mechanism coupled to the pressure vessel and, when actuated, interrupting permeate flow through the permeate outlet, while expelling at least a portion of the permeate stored in the permeate storage chamber through the permeate inlet such that permeate is temporarily flushed through the filter unit in a reverse direction.

2. The filtration system of claim 1 wherein the filter unit comprises at least one rigid porous tubular filter.

3. The filtration system of claim 1 wherein the front flush subsystem receives the permeate stream at a first predetermined pressure during operation of the filtration system, wherein the discharge mechanism is configured to expel the permeate collected in the permeate storage chamber at a second predetermined pressure upon actuation, and wherein the second predetermined pressure exceeds the first predetermined pressure by at least 10 pounds per square inch.

4. The filtration system of claim 1 wherein the permeate inlet is formed through the pressure vessel at a location beneath the permeate outlet.

5. The filtration system of claim 1 wherein the discharge mechanism comprises:
a piston slidably mounted in the pressure vessel for movement between a standby position and a flush position; and
an actuator operably coupled to the piston and, when actuated, configured to move the piston from the standby position to the flush position.

6. The filtration system of claim 5 wherein the piston blocks permeate flow through the permeate outlet in the flush position.

7. The filtration system of claim 5 wherein the actuator comprises a solenoid coupled to the piston and, when energized, moving the piston from the standby position to the flush position

8. The filtration system of claim 6 further comprising a control chamber provided in the pressure vessel and containing a fluid acting on the piston in opposition to the permeate stored in the permeate storage chamber.

9. The filtration system of claim 8 wherein an unsealed annular clearance is provided between outer circumference of the piston and an inner circumference of the pressure vessel permitting fluid communication between the control chamber and the permeate storage chamber.

10. The filtration system of claim 8 wherein the actuator comprises:
a pressurized fluid source coupled to the control chamber; and
a flow control valve fluidly coupled between the pressurized fluid source and the control chamber, the flow control valve movable between: (i) a closed position wherein the flow control valve impedes fluid flow from the pressurized fluid source to the control chamber, and (ii) an open position wherein the flow control valve permits fluid flow from the pressurized fluid source to the control chamber to exert a force on the piston urging movement of the piston toward the flush position.

11. The filtration system of claim 10 wherein the pressurized fluid source comprises a pressurized air source.

12. The filtration system of claim 6 wherein the permeate stored within the permeate storage chamber exerts a force on the piston urging movement toward the standby position.

13. The filtration system of claim 6 wherein the piston is biased toward the standby position due, at least in part, to a difference in buoyancy between the piston and the permeate within the permeate storage chamber.

14. The filtration system of claim 6 wherein the pressure vessel is vertically-oriented, wherein the piston strokes in an upward direction when moving from the flush position to the standby position, and wherein the piston has a positive buoyancy when exposed to the permeate within the permeate storage chamber.

15. The filtration system of claim 1 wherein the pressure vessel further comprises a gas inlet fluidly coupled to the permeate storage chamber, and wherein discharge mechanism comprises:
a pressurized air source coupled to the pressure vessel; and
a first flow control valve fluidly coupled between the pressurized air source and the control chamber, the flow control valve movable between: (i) a closed position wherein the first flow control valve impedes gas flow from the pressurized fluid source to the control chamber, and (ii) an open position wherein the first flow control valve permits pressurized gas flow from the pressurized as source to the control chamber to exert a force on the collected permeate sufficient to expel the collected permeate through the permeate inlet.

16. A filtration system, comprising:
a filter unit configured to receive a pressurized feed stream and discharge a permeate stream; and
a front flush subsystem, comprising:
a pressure vessel having a permeate inlet fluidly coupled to the filter unit and configured to receive the permeate stream therefrom, a permeate storage chamber fluidly coupled to the permeate inlet and configured to store permeate therein, and a permeate outlet fluidly coupled to the permeate storage chamber; and
a piston slidably mounted in the pressure vessel for movement between: (i) a standby position wherein permeate received at the permeate inlet flows through the permeate storage chamber and is discharged from the permeate outlet, and (ii) a flush position wherein the piston blocks permeate flow through the permeate outlet, while expelling permeate stored in the permeate storage chamber through the permeate inlet such that permeate is temporarily flushed through the filter unit in a reverse direction.

17. The filtration system of claim 16 wherein, after movement into the flush position, the piston returns to the standby position due at least in part to a difference in buoyancy between the piston and the permeate stored within the permeate storage chamber.

18. A front flush subsystem utilized in conjunction with at least one filter unit configured to separate a pressurized feed stream into a reject stream and a permeate stream, the front flush subsystem comprising:
a pressure vessel having a permeate inlet configured to receive the permeate stream from the at least one filter unit, a permeate storage chamber fluidly coupled to the permeate inlet and configured to store a predetermined volume of permeate therein, and a permeate outlet fluidly coupled to the permeate storage chamber; and
a discharge mechanism coupled to the pressure vessel and, when actuated, interrupting permeate flow through the permeate outlet, while expelling at least a portion of the permeate stored in the permeate storage chamber through the permeate inlet such that permeate is temporarily flushed through the filter unit in a reverse direction.

19. The front flush subsystem of claim 18 wherein the discharge mechanism comprises:
a piston slidably mounted in the pressure vessel for movement between a standby position and a flush position; and
an actuator operably coupled to the piston and, when actuated, configured to move the piston from the standby position to the flush position.

20. The front flush subsystem of claim 18 wherein the actuator comprises one of the group consisting of a pressurized fluid source fluidly coupled to the pressure vessel and a solenoid coupled to the piston.
